(19) United States
(12) Patent Application Publication
(10) Pub. No.: US 2009/0077663 A1
(43) Pub. Date: Mar. 19, 2009

(54) Score-based intrusion prevention system

(75) Inventors: Yong Sun, Kanata (CA); Faud Khan, Osgoode (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/898,838

(22) Filed: Sep. 17, 2007

(51) Int. Cl. G06F 21/06

(52) U.S. Cl. 726/23

(57) ABSTRACT

A score-based method of preventing intrusion, and related apparatus and systems, including one or more of the following: receiving traffic including new packets; decoding a protocol for same; determining that no session exists to which the packets are associated; creating a session entry for a session corresponding to the packets; setting a total score for the session to zero; performing an anomaly analysis on the packets identifying an anomaly; adding an anomaly score for the anomaly to the total score for the session; determining that the total score for the session does not exceed a threshold; determining that the anomaly analysis is finished; determining that the signature of the received new packets matches a threat signatures; adding a score assigned to the threat signature to the total score for the session; determining that the total score for the session exceeds the threshold; and triggering a threat response action.

### BACKGROUND OF THE INVENTION

1. Field of the Invention

This invention relates generally to the prevention of unauthorized computer access.

2. Description of Related Art

The proliferation of attempts to gain unauthorized access to the proprietary computers of others is ubiquitous. Similarly various systems and methods of preventing unauthorized computer access are known. However, there is a need for improved systems and methods of preventing unauthorized computer access.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for a score-based intrusion prevention system, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

In various exemplary embodiments, an Intrusion Prevention System (IPS) uses both an anomaly analysis and one or more signature match techniques to recognize attack traffic. In various exemplary embodiments, the anomaly analysis includes that pertaining to protocol and statistical anomalies.

In various exemplary embodiments, the anomaly analysis and signature match approaches work independently of each other with different response mechanisms. It is believed to be difficult to uniquely identify an attack based on a single anomaly check or a single signature match. Correspondingly, this lack of dependency often results in many false positive alarms.

It is believed to be a challenge for security administrators to process a large number of alarms that include many false positives to discover actually concealed attacks. Thus, in various exemplary embodiments, the IPS uses a method that is able to combine the logic of small events to identify a large event from a source or sources or from a target destination or destinations. Accordingly, in various exemplary embodiments, the quantity of false positive alarms generated is significantly reduced. In this manner, various exemplary embodiments achieve a higher accuracy rate for identifying malicious traffic.

Various exemplary embodiments are external third-party applications called Security Information Management (SIM) systems. However, it is believed that such embodiments substantially increase hardware and software costs and correspondingly increase the complexity of the system. Thus, various exemplary embodiments improve over these disadvantages.

### BRIEF DESCRIPTION OF THE DRAWINGS

In order to better understand various exemplary embodiments, reference is made to the accompanying drawings, wherein:

FIG. 1 is a schematic diagram of a first exemplary embodiment of a score-based intrusion prevention system;

FIG. 2 is a schematic diagram of a second exemplary embodiment of a score-based intrusion prevention system;

FIG. 3 is a flow-chart of an exemplary method of score-based prevention; and

FIG. 4 is an exemplary embodiment of traffic process in a score-based intrusion prevention system.

### DETAILED DESCRIPTION OF THE PREFERRED EMBODIMENTS OF THE INVENTION

While processing packets, various exemplary embodiments use a process of combining weighted values to anomalous and signature analysis to determine a session's risk factor. In various exemplary embodiments, as packets are processed they traverse several processing engines that assign a score to this activity. In various exemplary embodiments, if the assigned score exceeds a preset threshold for activity, an action module performs an action such as resetting the session or dropping the packets.

For example, assume an action score value or threshold of 25. A user starts up an IM client that can stream a large volume of UDP based traffic. In some instances this traffic can resemble a Denial of Service (DoS). In this example, the anomaly engine scores this a 10. However, upon further inspection within the signature engine, the traffic in question is deemed to be harmless and scored 0. With a total session value of 10(10+0=10) and an action score threshold of 25, no action is taken in this example.

However, as the session in question is further tracked, if malicious code is later injected into the UDP stream, in various exemplary embodiments the signature engine would detect the injection of the malicious code. In various exemplary embodiments the session score would be increased above the action threshold as a result of the detection of the malicious code. In various exemplary embodiments, the packet or session is dropped in response to the session score equaling or exceeding the action threshold value.

In various exemplary embodiments, predefined actions are taken for each event. In contract, other embodiments assign numeric values (scores) are to each signature and anomaly event. Furthermore, various exemplary embodiments limit the types of signatures based on the anomaly activity. Accordingly, various exemplary embodiments reduce the processing time and increase the performance.

For example, a packet is sent that contains a large proportion of hex 90 values. This is interpreted to indicate a possible buffer overflow. In various exemplary embodiments, the signature analysis is then focused on known buffer overflows.

In various exemplary embodiments, analysis is based on the current IPS methodology to determine the likelihood that a particular event is an attack and the severity of the potential attack. In various exemplary embodiments, the system performs the analysis and matches events in a manner similar to that of an IPS.

In various exemplary embodiments, where a match is found, the score of the matched entry is added to the total score of that specific session. In various exemplary embodiments, each new session has a default score of zero. In various exemplary embodiments, once the total score exceeds a predetermined threshold, one or more predetermined threat response actions are triggered. The predetermined threat response actions include, but are not limited to, logging the occurrence of the event, triggering an alarm, rejecting traffic, and redirecting traffic.

Referring now to the drawings, in which like numerals refer to like components or steps, there are disclosed broad aspects of various exemplary embodiments.

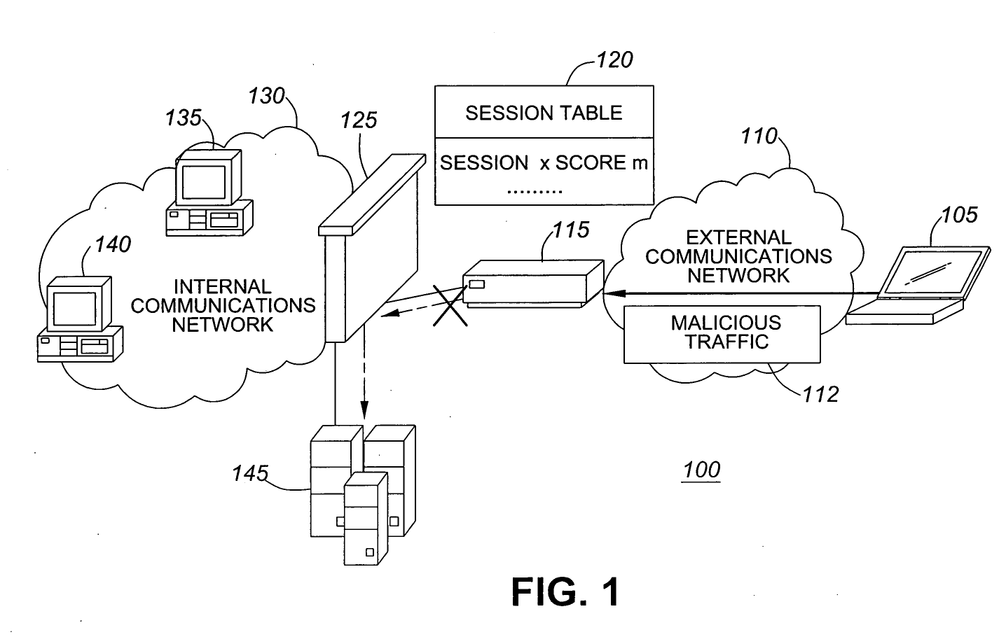

FIG. 1 is a schematic diagram of a first exemplary embodiment of a score-based intrusion prevention system 100. The system 100 includes a rogue user 105, an external communications network 110, a score-based IPS 115, a firewall 125, an internal communications network 130, and servers 145.

The rogue user 105 communicates malicious traffic 112 to the score-based IPS 115 through the external communications network 110. The score-based IPS 115 evaluates malicious traffic 112 and establishes session table 120 based on that evaluation.

Session table 120 includes session identifiers such as Session x and session scores such as score m. This will be discussed in greater detail below in connection with other figures.

In various exemplary embodiments, the external communications network 110 is the Internet. In various exemplary embodiments, the external communications network 110 is a telephone communications network, including, but not limited to, a cellular telephone communications network. In various exemplary embodiments, the external communications network 110 is any currently known, or later developed, form of a communications network through which the rogue user 105 can send malicious traffic 112.

The internal communications network 130 includes workstation 135 and workstation 140. As depicted in exemplary system 100, after malicious traffic 112 passes through score-based IPS 115, it is dropped by the score-based IPS 115. Thus, it does not pass to the firewall 125 and does not pass to the servers 145 as intended. This is represented in exemplary system 100 by the dotted arrows from score-based IPS 115 to firewall 125 and from firewall 125 to servers 145.

The solid arrow of malicious traffic 112 is changed to a dotted arrow after passing score-based IPS 115 because it has been identified as malicious. The space between firewall 125 and servers 145 represents a demilitarized zone (DMZ). In computer security, a DMZ, more appropriately known as demarcation zone or perimeter network, is a network area (a sub-network) located between an organization's internal network and an external network such as the Internet. The purpose of a DMZ is that connections are permitted to the DMZ from both the internal and the external network, but connections from the DMZ are only permitted to the external network.

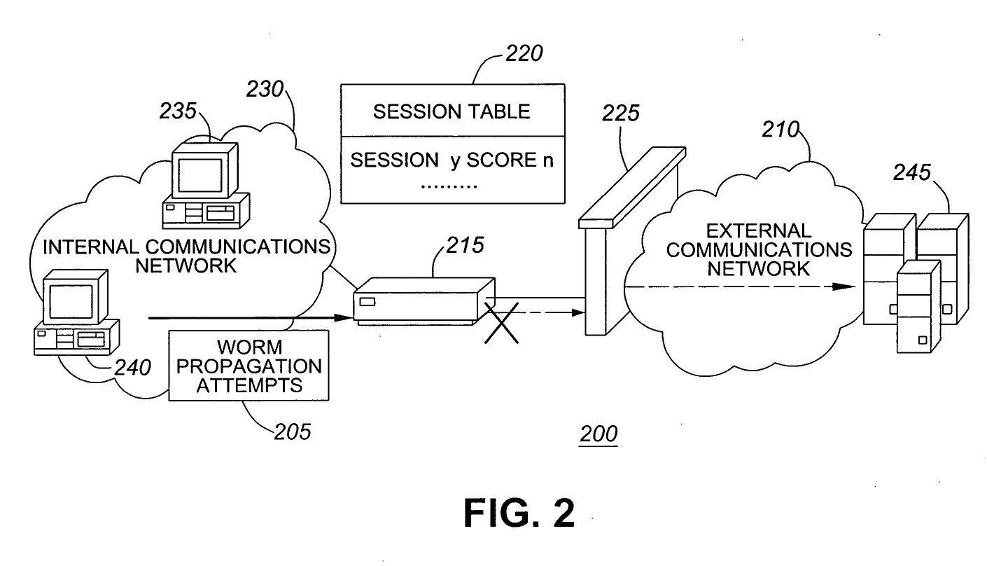

Thus, exemplary system 100 represents a system where the score-based IPS 115 is deployed outside a perimeter of the internal communications network 130 in front of the firewall 125. A second embodiment similar to exemplary system 100 is shown in FIG. 2.

FIG. 2 is a schematic diagram of a second exemplary embodiment of a score-based intrusion prevention system 200. Exemplary system 200 includes internal communications network 230, score-based IPS 215, firewall 225, external communications network 210 and servers 245.

In exemplary system 200, worm propagation attempts 205 are initiated within the internal communications network 230 from one of workstation 235 and workstation 240. The worm propagation attempts 205 are received by the score-based IPS 215.

The score-based IPS 215 creates a session table 220 based on an evaluation of the worm propagation attempts 205. Session table 220 corresponds somewhat to session table 120 as follows. Session indicator Session y is similar to session indicator Session x, and session score n is similar to session score m. Similarly, servers 245 correspond to servers 145, external communications network 210 corresponds to external communications network 110, firewall 225 corresponds to firewall 125, and so on.

As in exemplary system 100, the undesirable communication represented in exemplary system 200 by worm propagation attempts 205 are identified as undesirable by the score-based IPS 215. Thus, the X and the dotted arrows in system 200 denote that the worm propagation attempts 205 are unsuccessful and do not pass through firewall 225 to the external communications network 210 as maliciously intended.

In a third embodiment, not shown, the score-based IPS 115 and/or score-based IPS 215 are included within firewall 125 or firewall 225. The way that score-based IPS 115 and score-based IPS 215 identify undesirable communications and respond to this identification will be described in greater detail below in connection with other figures.

Generally speaking, exemplary system 100 depicts an exemplary embodiment where a score-based IPS 115 is deployed at the perimeter of a network 130. In contrast, exemplary system 200 depicts an exemplary embodiment where a score-based IPS 215 is deployed behind a firewall 225.

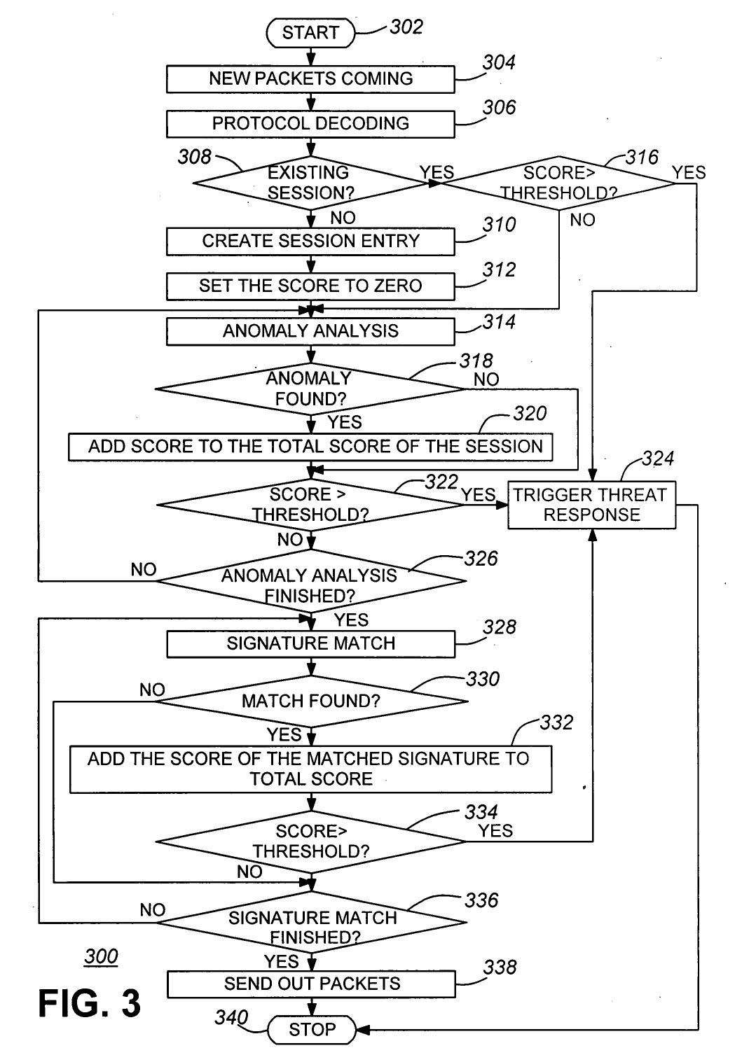

FIG. 3 is a flow chart of an exemplary method 300 of score-based prevention. The method 300 starts in step 302 and proceeds to step 304.

In step 304, new packets of data are coming. In other words, new packets of data are being transmitted and received in step 304.

Following step 304, the method 300 proceeds to step 306. In step 306, protocol decoding occurs on the new packets that arrive in step 304. Following step 306, the method 300 proceeds to step 308.

In step 308, an evaluation is made whether a session exists of which the new packets coming in step 304 are a part. When a determination is made in step 308 that the new packets coming in step 304 are part of an existing session, the method 300 proceeds to step 316.

In step 316, an evaluation is made whether a session score exceeds a predetermined threshold. This is essentially the same as an evaluation made in method 300 at step 322. Thus, this will be discussed in greater detail below in connection with step 322.

When a determination is made in step 308 that the new packets coming in step 304 do not pertain to an existing session, the method 300 proceeds to step 310. In step 310, a new session entry is created for the session begun by the new packets coming in step 304.

Following step 310, the method 300 proceeds to step 312. In step 312, the score for the new session entry created in step 310 is set to zero. Following step 312, the method 300 proceeds to step 314. Similarly, when a determination is made in step 316 that the score of an existing session does not exceed the predetermined threshold, the method 300 also proceeds to step 314.

In step 314, an anomaly analysis is performed on the new packets coming in step 304. The method 300 then proceeds to step 318. In step 318, an evaluation is made whether an anomaly is found in the new packets coming in step 304, based on the analysis performed in step 314.

When a determination is made in step 318 that no anomaly is found in the analyzed packets, the method 300 proceeds to step 322. However, when a determination is made in step 318 that an anomaly is found in the packets being analyzed, the method 300 proceeds to step 320.

In step 320, a score is assigned to the found anomaly and added to the total score for the session. In various exemplary embodiments, the score assigned in step 320 corresponds to a score previously assigned to the type of anomaly found in step 318.

In various exemplary embodiments, a variety of scores are pre-assigned to a plurality of known anomalies. Thus, in various exemplary embodiments, the score added to the total score of the session in step 320 is determined by retrieving a previously assigned score from a database archiving the pre-assigned scores assigned to known anomalies. In various exemplary embodiments, the magnitude of the scores assigned to known anomalies increases in correlation to a level of risk attributed to each anomaly.

Following step 320, the method 300 proceeds to step 322. In step 322, as in step 316, an analysis is made whether the total score for the session exceeds a predetermined threshold.

When a determination is made in step 316 that the total session score exceeds a predetermined threshold, the method 300 proceeds to step 324. Likewise, when a determination is made in step 322 that the total session score exceeds a predetermined threshold, the method 300 proceeds to step 324. In step 324, a threat response is triggered. In various exemplary embodiments, the threat response triggered in step 324 takes on a wide variety of forms.

In various exemplary embodiments, the threat response triggered in step 324 varies according to a hierarchy of threat levels. For example, in various exemplary embodiments, three threat levels are used. In various exemplary embodiments, colors are assigned to three discrete threat levels, such as yellow, orange and red.

In various exemplary embodiments, the threat response triggered in step 324 when the total session score exceeds a threshold set for a threat level of yellow is the creation of a log entry to log the identification of the threat. In various exemplary embodiments, the threat response triggered in step 324 when the total session score exceeds a threshold set for an orange threat level, is activation of an alarm. Correspondingly, in various exemplary embodiments, when the total score for the session exceeds a threshold set for a red threat level, the threat response triggered in step 324 is to reject the incoming packets.

In various exemplary embodiments, when the total score of a session exceeds the threshold set for a red threat level, the threat response triggered in step 324 includes both the threat response action corresponding to the red threat level and the threat response action corresponding to the orange threat level. Likewise, in various exemplary embodiments, any combination of threat responses assigned to various threat levels up to the highest threat level achieved by the total session score, including any lower threat levels, are implemented in step 324.

In various exemplary embodiments, the combination of threat responses triggered based on any particular identified anomaly is predetermined and defined by a system administrator. In various exemplary embodiments, the combination of threat responses from lower threat levels triggered in step 324 varies based on the anomaly found.

When a determination is made in step 322 that the total score does not exceed any predetermined threshold, the method 300 proceeds to step 326. In step 326 an evaluation is made whether the anomaly analysis has been completed. In various exemplary embodiments, a determination is made that the anomaly analysis is finished when the packets being evaluated have been evaluated with respect to all known anomalies.

When a determination is made in step 326 that the anomaly analysis is not finished, the method 300 returns to step 314. When a determination is made in step 326 that the anomaly analysis is finished, the method 300 proceeds to step 328.

In step 328 a signature match analysis is performed. Following step 328, the method 300 proceeds to step 330. In step 330, an evaluation is made whether a signature match is found as a result of the signature match analysis performed in step 328. When a determination is made in step 330 that no signature match is found, the method 300 proceeds to step 336. When a determination is made in step 330 that a signature match is found, the method 300 proceeds to step 332.

In step 332, a score assigned to the signature match found in step 328 is added to the total score of the session. Following the addition of the score associated with the signature match found to the total session score in step 332, the method 300 proceeds to step 334.

In step 334, an analysis is performed whether the total score of the session exceeds a predetermined threshold. Thus, the analysis performed in step 334 corresponds to the analysis performed in step 322 and the analysis performed in step 316. As with step 316 and step 322, when a determination is made in step 334 that the score exceeds a predetermined threshold, the method 300 proceeds to step 324. Step 324 is discussed in greater detail above. Following step 324, the method 300 proceeds to step 340 where the method 300 stops.

When a determination is made in step 334 that the total session score does not exceed a predetermined threshold, the method 300 proceeds to step 336. In step 336, a determination is made whether the signature match analysis is completed. When a determination is made in step 336 that the signature match analysis is not completed, the method 300 returns to step 328 where the signature match analysis continues.

When a determination is made in step 336 that the signature match analysis is finished, the method 300 proceeds to step 338. When the method reaches step 338, this corresponds to a complete analysis of the new packets coming in step 304, wherein the total session score assigned throughout the method 300 never exceeded any predetermined threshold.

Thus, in step 338, the packets being analyzed are sent out according to their originally intended destination. This action in step 338 is determined to be safe when a total session score for the packets in question never exceeds any predetermined threshold because the packets are determined not to be a threat. Following step 338, the method 300 proceeds to step 340 where the method stops.

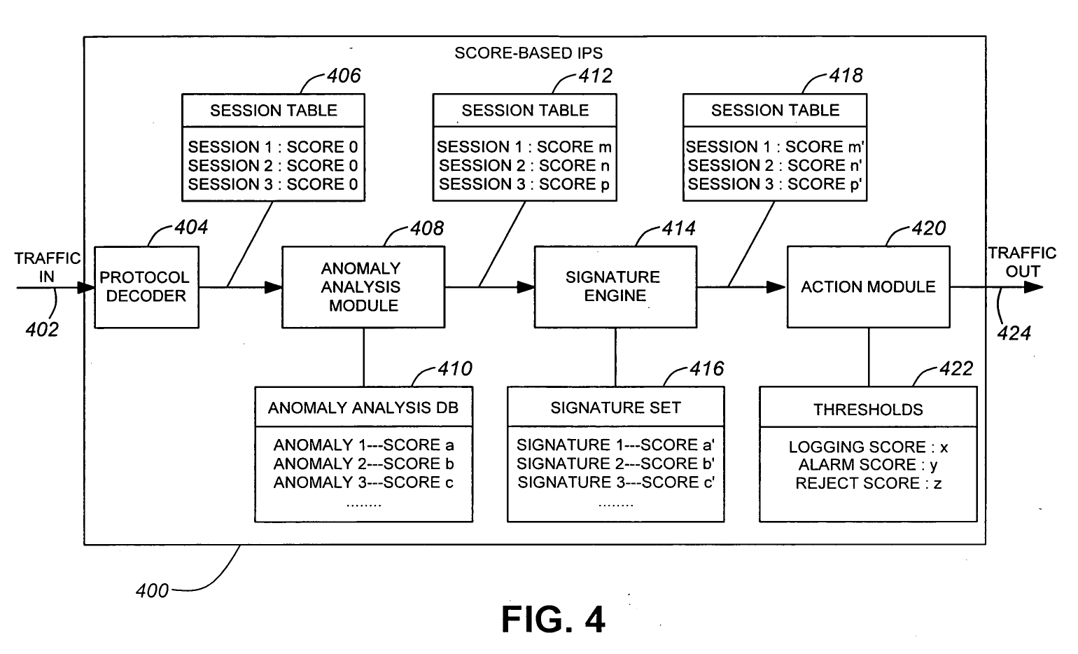

FIG. 4 is an exemplary embodiment of traffic process 400 in a score-based intrusion prevention system. Traffic process 400 includes a protocol decoder 404, an anomaly analysis module 408, a signature engine 414 and an action module 420. Traffic in 402 enters the traffic process 400 and proceeds to the protocol decoder 404.

Traffic then flows from protocol decoder 404 to anomaly analysis module 408 with a score-based IPS session table 406 associated therewith. The anomaly analysis module 408 then applies anomaly analysis database (DB) 410 to the traffic.

The traffic then proceeds from anomaly analysis module 408 to signature engine 414 with session table 412 associated therewith. Signature engine 414 then analyzes the traffic by applying signature set 416.

The traffic then travels from signature engine 414 to action module 420 with session table 418 associated therewith. The action module 420 then acts on the traffic by applying thresholds included in threshold table 422. Traffic out 424 then exits the traffic process 400 from the action module 420.

Session table 406, session table 412 and session table 418 correspond to session table 120 and session table 220, previously discussed. Although each of session table 406, session table 412 and session table 418 show three sessions, that is, Session 1, Session 2 and Session 3, it should be understood that any number of sessions can be included in any of session table 120, session table 220, session table 406, session table 412 and session table 418. Likewise, score m, score n, score p, score m′, score n′ and score p′ correspond to score m and score n described above in connection with session table 120 and session table 220.

As depicted, anomaly analysis database (DB) 410 includes Anomaly 1, Anomaly 2 and Anomaly 3. It should be understood that anomaly analysis database 410, in various exemplary embodiments, includes any number of anomalies other than the three depicted anomalies. The application of the anomaly analysis database 410 by the anomaly analysis module 408 is discussed above in greater detail above in connection with step 314 of exemplary method 300. The three scores depicted in anomaly analysis DB 410, score a, score b and score c, represent three scores assigned to the three anomalies included in anomaly database 410.

As depicted in traffic process 400, the signature set 416 includes three signatures, namely, Signature 1, Signature 2 and Signature 3. It should be apparent that, in various exemplary embodiments, signature set 416 includes any number of signatures other than three.

As depicted, Signature 1 is assigned a score of a′, Signature 2 is assigned a score of b′ and Signature 3 is assigned a score of c′. The application of signature set 416 to the analysis performed by the signature engine 414 is described in greater detail above connection with step 328 of exemplary method 300.

The threshold table 422 depicted in exemplary process 400 includes a logging score x, an alarm score y and a reject score z. It should be apparent that in various exemplary embodiments, the threshold table 422 includes any number of thresholds other than three. The application of the threshold table 422 by the action module 420 is described in greater detail above in connection with steps 316, 322, 324 and 334 of exemplary method 300.

Accordingly, it should be apparent that various exemplary embodiments incorporate one or more elements discussed herein in connection with exemplary method 300 and one or more elements discussed herein in connection with exemplary traffic process 400. The following discussion pertains to various exemplary embodiments of various combinations of these disclosures.

Various exemplary embodiments are a system that includes four modules, the protocol decoder 404, the anomaly analysis module 408, the signature engine 414 and the action module 418. As the names of these modules imply, in various exemplary embodiments, the protocol decoder 404 parses various protocols. In various exemplary embodiments, the protocol decoder 404 creates and maintains a session table. In various exemplary embodiments, the anomaly analysis module 408 performs various protocol and statistical anomaly checks. In various exemplary embodiments, the signature engine 414 performs the signature match functions. In various exemplary embodiments, the action module 420 deals with the traffic in 402 based on the scores and thresholds discussed herein.

In various exemplary embodiments, different scores are assigned to every protocol anomaly check, every statistical anomaly check and every signature detection analysis. Using a specific numerical example, every protocol anomaly check has a score of three, every reconnaissance signature is assigned a score of three, and all buffer overflow attack signatures are assigned a score of ten. In various exemplary embodiments, a threshold of five is assigned for logging, a threshold of ten is assigned for an alarm, and a threshold of fifteen is assigned for the rejection of the packet being analyzed.

The following consists of a written description of an example of the processing of an exemplary session. When new packets come, the protocol decoder 404 creates a new entry in a session table and sets the score of the new entry to zero because no session entry currently exists for the new packets.

In various exemplary embodiments, the state of the session is also tracked. When the identified packets belong to an existing session whose score already exceeds a predefined threshold, then the anomaly analysis module 408 and the signature engine 414 are bypassed in various exemplary embodiments such that the action module 420 immediately handles those packets.

In various exemplary embodiments, a session is distinguished by the source IP address, destination IP address, source port and destination port for UDP and established TCP connection; by source IP address, destination IP address and protocol type for ICMP; and by source IP address, destination IP addresses and protocol number for other protocols. In various exemplary embodiments, session information, including a total session score, is stored in a memory table or in a ternary content addressable memory (TCAM) for fast access. In various exemplary embodiments, each session entry will time out after being idle for a predetermined period of time and after the session has been finished gracefully.

Similarly, when an analysis performed by the anomaly analysis module 408 results in a conclusion that a total score assigned to the session has exceeded a threshold, the signature engine 414 is bypassed such that the traffic is immediately forwarded to the action module 420 for further processing. Correspondingly, in various exemplary embodiments, the traffic only passes from the anomaly analysis module 408 to the signature engine 414 when a total score for the corresponding session is below all pertinent thresholds.

Put differently, anytime the total score of a session exceeds any predetermined threshold, the traffic proceeds immediately to the action module 420. When exemplary method 300 reaches step 338, this corresponds to traffic passing through the action module 420 without any action being taken. Once a session entry is set up, all subsequent packets for the existing session that begin in exemplary method 300 in step 304 use the existing session entry that already exists. This corresponds to a flow in exemplary method 300 from step 308 to step 316 and bypassing at least step 310 and step 312.

According to the foregoing, in various exemplary embodiments, the total number of false-positives is reduced significantly. Accordingly, in various exemplary embodiments, a security administrator saves lots of time necessary to process alarms in order to identify real attacks.

In various exemplary embodiments, the alarms triggered by various anomaly checks and signature matches are correlated without the help of an external application. In various exemplary embodiments, some attacks are easily discovered and identified.

Various exemplary embodiments are incorporated to achieve more intelligent network intrusion detection and prevention systems. Various exemplary embodiments are integrated into routing or switching products. Alternatively, various exemplary embodiments are implemented as a stand alone product. Various exemplary embodiments are implemented in host-based intrusion detection systems.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A score-based method of preventing intrusion, comprising:
receiving traffic including new packets;
decoding a protocol for the received new packets;
determining that no session exists to which the received new packets are associated;
creating a session entry for a session corresponding to the received new packets;
setting a total score for the session to zero;
performing an anomaly analysis on the received new packets;
identifying an anomaly present in the received new packets;
adding an anomaly score corresponding to a score assigned to the identified anomaly to the total score for the session;
determining that the total score for the session does not exceed a predetermined threshold;
determining that the anomaly analysis is finished;
performing a signature match analysis to determine whether a signature of the received new packets matches a plurality of predefined threat signatures;
determining that the signature of the received new packets matches at least one of the plurality of predefined threat signatures;
adding a score assigned to the at least one of the plurality of predefined threat signatures to the total score for the session;
determining that the total score for the session exceeds the predetermined threshold; and
triggering a threat response action.

2. The score-based method of preventing intrusion, according to claim 1, wherein performing the anomaly analysis includes analyzing the received new packets for protocol anomalies and statistical anomalies.

3. The score-based method of preventing intrusion, according to claim 1, wherein the threat response action is selected from the list consisting of creating a log entry logging the occurrence of an identified threat, triggering an alarm, rejecting the session, dropping the received new packets, resetting the session, and redirecting the traffic.

4. The score-based method of preventing intrusion, according to claim 1, further comprising assigning individual values to each known anomaly and threat signature.

5. The score-based method of preventing intrusion, according to claim 1, wherein a number of signatures analyzed is limited based on the identified anomaly.

6. The score-based method of preventing intrusion, according to claim 1, further comprising retrieving a score for the identified anomaly from an anomaly analysis database.

7. The score-based method of preventing intrusion, according to claim 1, further comprising retrieving a score for the at least one of the plurality of threat signatures from a threat signature set table.

8. The score-based method of preventing intrusion, according to claim 1, further comprising determining that the total score for the session exceeds a plurality of thresholds.

9. The score-based method of preventing intrusion, according to claim 8, further comprising triggering a plurality of threat response actions.

10. The score-based method of preventing intrusion, according to claim 9, wherein the plurality of threat response actions include creating a log entry documenting the occurrence of an identified threat and triggering an alarm.

11. The score-based method of preventing intrusion, according to claim 10, wherein the plurality of threat response actions includes rejecting the session.

12. A score-based intrusion preventing system, comprising:
a firewall;
a score-based intrusion prevention apparatus, the firewall being between the score-based intrusion prevention apparatus and an external communications network; and
an internal communications network including a plurality of workstations,
wherein the score-based intrusion prevention apparatus identifies a worm propagation attempt initiated from a one of the plurality of workstations and prevents the worm propagation attempt from passing through the firewall to the external communications network.

13. A score-based intrusion prevention system, comprising:
a score-based intrusion prevention apparatus;
a firewall, the score-based intrusion prevention apparatus being between the firewall and an external communications network;
a plurality of servers in communication with the firewall through a demilitarized zone; and
an internal communications network including a plurality of workstations,
wherein the score-based intrusion prevention apparatus identifies malicious traffic sent through the external communications network from a rogue user by assigning a plurality of scores to the malicious traffic and determining that a sum of the plurality of scores exceeds a predetermined threshold.

14. The score-based intrusion prevention system, according to claim 13, wherein the score-based intrusion prevention apparatus prevents malicious traffic from reaching the plurality of servers through the demilitarized zone.

15. A score-based intrusion prevention system, comprising:
a protocol decoder for decoding a protocol of a received packet, setting up a session for transmission of the received packet, creating a session entry corresponding to the session in a session table and setting a score for the session to zero;
and anomaly analysis module for analyzing the received packet for the presence of one or more anomalies, identifying an anomaly present in the received packet, adding a score corresponding to the anomaly to a total score for the session, determining that the total score for the session does not exceed a predetermined threshold and determining that an anomaly analysis is finished;
a signature engine module for evaluating whether a signature of the received packet matches a previously known signature, determining that the signature of the received packet matches the previously known threat signature, and assigning a score corresponding to the previously known threat signature to the total score of the session; and
an action module for determining that the total score of the session exceeds a predetermined threshold and triggering a threat response to the previously known threat signature.

16. The score-based intrusion prevention system, according to claim 15, wherein the score corresponding to the anomaly is obtained from an anomaly analysis database.

17. The score-based intrusion prevention system, according to claim 15, wherein the score associated with the previously known threat signature is obtained from a signature set table.

18. The score-based intrusion prevention system, according to claim 15, wherein a firewall encompasses the protocol decoder, the anomaly analysis module, the signature engine module and the action module.

19. The score-based intrusion prevention system, according to claim 15, wherein the protocol decoder, the anomaly analysis module, the signature engine module and the action module are deployed at the perimeter of an internal communications network in order to prevent malicious traffic sent from a rogue user through an external communications network from passing through a firewall to servers in a demilitarized zone.

20. The score-based intrusion prevention system, according to claim 15, wherein the protocol decoder, the anomaly analysis module, the signature engine module and the action module are located between a firewall and an internal communications network in order to prevent worm propagation attempts sent from within the internal communications network from passing through the firewall to an external communications network.
